(19) United States
(12) Patent Application Publication
(10) Pub. No.: US 2025/0352425 A1
(43) Pub. Date: Nov. 20, 2025

(54) Therapeutic Device

(71) Applicant: Michael A Cohen, Toronto (CA)

(72) Inventor: Michael A Cohen, Toronto (CA)

(21) Appl. No.: 19/195,520

(22) Filed: Apr. 30, 2025

Related U.S. Application Data
(63) Continuation-in-part of application No. 17/129,532, filed on Dec. 21, 2020, now abandoned.
(60) Provisional application No. 62/951,293, filed on Dec. 20, 2019.

(51) Int. Cl. A61H 15/02

(52) U.S. Cl. CPC A61H 15/02; A61H 2201/0207; A61H 2201/0221; A61H 2205/04

(57) ABSTRACT

A therapeutic device comprises an upper massage surface having a generally central spinous channel, a first domed portion on a first lateral side of the central spinous channel and a second domed portion on a second lateral side of the central spinous channel. The device has lower base surface, a front edge, a rear edge, and the upper massage surface extending between front edge and the rear edge. A first lateral edge is provided on one side of the therapeutic device and a second lateral edge provided on an opposing side of the therapeutic device. Further, there is a first ridge near the rear edge extending upwardly between the central spinous channel and the first lateral edge, and a second ridge near the rear edge extending upwardly between the central spinous channel and the second lateral edge.

### CROSS REFERENCE TO RELATED APPLICATIONS

This application is a continuation in part application of U.S. patent application Ser. No. 17/129,532 filed Dec. 21, 2020, which claims the benefit of U.S. Provisional Patent Application No. 62/951,293 filed Dec. 20, 2019. This application is also a continuation in part application of U.S. patent application Ser. No. 17/126,568 filed Dec. 18, 2020. The contents of both of the above applications are incorporated herein by reference in their entirety.

### FIELD AND BACKGROUND OF THE INVENTION

This invention relates to a therapeutic device. More particularly, the invention is for a therapeutic device having shapes and contours which are configured to massage the body of a person. In one particular form of the invention, the therapeutic device is constructed so as to facilitate or assist in the improvement to the neck support of the user. The therapeutic device can be placed relative to the user while the user is in a sitting position, to guide posture, or it may be used when the user is lying down or any other intermediate position.

### SUMMARY OF THE INVENTION

According to one aspect of the invention, there is provided a therapeutic device comprising: an upper massage surface having a generally central spinous channel, a first domed portion on a first lateral side of the central spinous channel and a second domed portion on a second lateral side of the central spinous channel; a lower base surface; a front edge; a rear edge, the upper massage surface extending between front edge and the rear edge; a first lateral edge on one side of the therapeutic device and a second lateral edge on an opposing side of the therapeutic device; a first ridge near the rear edge extending upwardly between the central spinous channel and the first lateral edge; and a second ridge near the rear edge extending upwardly between the central spinous channel and the second lateral edge.

Preferably, the first domed portion comprises an outer curved surface and a plurality of projections extending upwardly and outwardly from the outer curved surface. The first domed portion may have a circumferential edge at its base, the circumferential edge being adjacent the central spinous channel. The first domed portion may have a diameter which is about one fourth, or one third, of the distance between front edge and the rear edge. The first domed portion may be located on the upper massage surface in a position nearer the front edge, and may be adjacent the central spinous channel about equidistant from each of the rear edge and front edge. The plurality of projections extending outwardly from the outer curved surface of the first domed portion may each have a base, a short cylindrical shaft portion and a rounded end, the projections having an axis which is about normal to the outer curved surface where the base attaches to the outer curved surface. The rounded ends of the projections may together define an arcuate configuration with spaces therebetween.

In one embodiment, the upper massage surface has an apex between the front and rear edges adjacent the central spinous channel, curves down on each side toward the front and rear edges respectively, and further curves downwardly form the central spinous channel toward the first and second lateral edges respectively. There may be a plurality of large projections on the upper massage surface on each side of the central spinous channel, the plurality of large projections being positioned on the upper massage surface so as to extend from along the central spinous channel toward the first or second lateral edge respectively. There may also be a plurality of small projections extending from the large projections to the first or second lateral edge receptively. The large projections and the small projection may each have a base, a cylindrical shaft and a hemispherical end portion.

The therapeutic device may comprise a plurality of mixed size projections near the front edge thereof.

Preferably, the first ridge and the second ridge each have a plurality of ridge projections extending outwardly therefrom. Further, at least one of the first or second lateral edges may have a pair of opposing lateral wall portions which taper or slope inwardly toward the center of the lateral edge, a concave curved portion at about the center of the lateral edge, and a plurality of lateral wall projections extending outwardly from the lateral edge.

There may be a material in the device which can be heated and which is able to maintain heat. This may comprise a fill material in the interior of the device which is heatable and which is able to maintain heat.

According to another aspect of the invention, there is provided a method of forming a therapeutic device comprising: providing an upper massage surface having a generally central spinous channel, a first domed portion on a first lateral side of the central spinous channel and a second domed portion on a second lateral side of the central spinous channel; providing a lower base surface; providing a front edge; providing a rear edge, the upper massage surface extending between front edge and the rear edge; providing a first lateral edge on one side of the therapeutic device and a second lateral edge on an opposing side of the therapeutic device; providing a first ridge near the rear edge extending upwardly between the central spinous channel and the first lateral edge; and providing a second ridge near the rear edge extending upwardly between the central spinous channel and the second lateral edge.

According to yet a further aspect of the invention, there is provided a method of massaging using a therapeutic device comprising: providing an upper massage surface having a generally central spinous channel, a first domed portion on a first lateral side of the central spinous channel and a second domed portion on a second lateral side of the central spinous channel; providing a lower base surface; providing a front edge; providing a rear edge, the upper massage surface extending between front edge and the rear edge; providing a first lateral edge on one side of the therapeutic device and a second lateral edge on an opposing side of the therapeutic device; providing a first ridge near the rear edge extending upwardly between the central spinous channel and the first lateral edge; providing a second ridge near the rear edge extending upwardly between the central spinous channel and the second lateral edge; and heating the therapeutic device to a temperature to enhance the therapeutic effect.

In one aspect, therefore, the therapeutic device of the invention is designed so as to preferably have a small and compact and easy to use size in order to provide better support for the neck, such as when speaking on a cell phone, when the user the user is sitting, or when in the sitting position, or to correct a forward tilt of the head in a forward leaning position when on the cell phone, or during other activities which may result in this posture. This is practically important in today's society where many cell phone users or computer users, or other sedentary workers, tend to lean their heads forward, when interacting with their cell phone or computer or other items or machines in their workspace. This may have the effect of causing a deleterious strain on the neck and/or related muscles, the spine, or other body parts, and may, further, cause organ compression such as in the front of the body, although not limited to this area. In fact, this compression, which may be sustained over long periods, has been linked to increased rates of colon pathology and decreased respiratory capacity.

In one aspect of the invention, it is intended that the therapeutic device be placed on the chair on which the user is sitting, behind the back of the neck of the user or even located anywhere along the length of the spine, preferably the upper part thereof. One preferred position for the therapeutic device would be near the neck and the top of the spine, or in the natural hollow defined by the neck between the back and the head of the user, but it could be used at a lower location or other locations. It should be noted that the device and its various embodiments are not confined to any particular position, and different configurations and sizes may be created for use in different situations and positions.

Many people use their cell phones with their head tilted in a forward leaning position, sometimes to hold or clamp the phone between the head and the shoulder to free up the hands. This may create significant negative effects on the spinal joints, discs, connective and muscle tissues of the neck. Some research has in fact shown this position may also have negative affects on the users' cognitive function and mood. Over a period of time, this repeated forward head tilt can negatively affect the user's overall posture, since the body can become conditioned to this state, and may assume such a position even when the person is not in fact using a cell phone.

In one aspect of the invention, one embodiment of the therapeutic device of the invention may be placed under the neck of a user while lying down. Preferably, this is done for a minimum of about 10 to 15 minutes per day, although the invention is not limited to such treatment times or frequencies. Utilizing the therapeutic device of the invention may help to release tight musculature and encourage structural normalization of the spinal neck joints and connective tissue, and this may occur when the treatment regimen is followed by the user at more frequent intervals and for longer stretches.

The therapeutic device of the invention may include one or more, or all, of the features and components which are listed below.

(1) The therapeutic device of the invention comprises a central, or near central, recessed groove or channel, which may in one embodiment be angled at a convex arc of approximately 30 degrees to create an extension in the spine and facilitating the reversing of the compressive spinal effects inherent in forward head leaning or tilting. This generally centrally located recessed groove or channel preferably has dimensions which are configured to accommodate the spinous processes of the user while lying down. The result may include reduced load on the muscles, joints and discs, thereby creating better spinal health and more comfort to the end user. Note that the approximately 30° angle referred to above may be a preferred form of the invention, but the therapeutic device would not be limited to such a specific construction.

(2) The therapeutic device may be heatable so that the heat or warmth of the device so generated facilitates expansion of tight muscle and connective tissue, calms the central nervous system, preferably by creating deeper tissue release, reduced pain sensitivity and a more relaxing experience for the end user. The use of the therapeutic device may further help to improve tissue blood and lymph flow, aiding the release of built up muscle wastes that perpetuate or even amplify pain. This heat effect may be accomplished, for example, by placing the therapeutic device in a microwave for about 90 seconds, or boiling it for about 12 minutes, and this may create about 2 hours of continuous heat at a temperature of about 100-102 degrees F. Of course, other heating times are included within the scope of the invention, as are different heating methods and structures as will be further described below. The amount of heating and the extent of heating may also be modulated according to specific treatments and regimens which may be selectively used, so that an optimal level of warmth may be provided in a specific situation.

(3) The therapeutic device of the invention preferably incorporates two hemispheric or rounded or convex structures on either side of the central recessed spinal groove. These structures, whatever their specific shape, have an arcuate or curved surface thereon. These hemispheric structures are each preferably designed with about up to a 180 degree array of acupressure points to specifically provide an acupressure relaxation effect on, for example, the erector spinae muscles on either side of the spine. These are the muscles that bear the majority of the load when the user is in the sitting position, which causes them to tighten. A wide range of variations in the shape of the hemispheric structures and the rounded surface on such structures are possible within the scope of the invention. Thus, these structures may be, for example, elliptical, have an increased or decreased dome-shaped, or other configuration. There may be a combination of shapes which make up the structures, or they may irregular. Further, the hemispheric or rounded structures may incorporate on the surface thereof a plurality of upwardly or outwardly extending projections or nibs which are able to provide acupressure points to facilitate the therapeutic effect of the device of the invention.

(4) The therapeutic device also comprises a specific nib configuration which aims inward at about a 20 degree angle on either side of the central recessed spinal groove or channel to create an acupressure effect on the portion of the erector spinae muscles directly adjacent to the spine. However, variations in the size and shape of these nibs, as well as their angles relative to the rounded surface of the therapeutic device as well as the recessed groove, would certainly fall within the scope of the invention, and these may be selected based on the shape and configuration of the therapeutic device, its size, its optimal intended location, nature of the interaction with the user, and such other parameters that may help to determine their position and orientation.

(5) In one embodiment, the therapeutic device of the invention also comprises a concave hemispheric or rounded or curved slope featuring a specific two stage acupressure nib configuration (for example, smaller and larger nibs) on the main body of the device to both accommodate and release the bulk of the erector spinae muscles thereby delivering maximum ergonomic comfort and tissue release to the user. Furthermore, the invention also contemplates a multitude of different nib or projection sizes and configurations on the device, and wherein each of the different nib or projection sizes may be strategically located on the surface so as to potentially coincide with muscles or skin or other types of body tissue of the user with which the therapeutic device will have contact or adjacent positioning.

(6) The therapeutic device may comprise a concave ridge with small or selectively sized acupressure nibs on the top end of the device designed to hold and cradle the suboccipital bones of the end user which, in combination with the device's central convex arc, may create a notable traction effect encouraging spinal decompression throughout the cervical spine.

(7) The therapeutic device may further comprise a specifically designed acupressure point grouping on the front end of the device in order to provide deeper decompressive traction effects on the suboccipital area when the device is placed on its end. Such acupressure point groupings may also be on the opposing end of the device, and these acupressure point groupings on each side of the device may be different from each other in order to meet different treatment preferences and regimens.

(8) Further, the therapeutic device may have on one side, or both sides, of the device a specific grouping of acupressure points with a concave orientation, which may be designed to release tightness in the muscles in the front and side of the neck when held adjacent to those muscles by hand. Such acupressure points may also be alternatively or additionally placed on other sides of the device, and the points may be differently sized and angled on opposing sides of the device, with different densities, in order to meet different treatment preferences and regimens.

According to one aspect of the invention, there is therefore provided a therapeutic or massage device having a contoured and shaped operating surface, the operating surface including a recessed spinal groove or channel, a hemispheric or rounded structure on the operating surface on at least one side of the recessed spinal groove, a plurality of nibs or projections formed on the hemispheric or rounded structure, a plurality of nibs or projections which may be of varying size and shape and density formed on the operating surface around the hemispheric structures, a ridge having a top end extending generally upwardly from the operating surface, and a plurality of outwardly extending projections formed on the top end of the ridge.

Preferably, there is a hemispheric or rounded structure on each side of the recessed groove, and the hemispheric structures may be located along the recessed groove toward a top or bottom edge of the therapeutic device. In other words, the hemispheric structures may be other than centrally located along the recessed groove. Further, the hemispheric structures may have variations in their shape and size. Preferably, the recessed groove itself is generally centrally located over the upper surface of the therapeutic device.

In one form of the invention, some or all of the nibs or projections formed on the hemispheric structure as well as the operating surface around the hemispheric structures project outwardly or away from the hemispheric or rounded structure or operating surface respectively at substantially right angles to the surface at their point of connection to the surface and from which they project, or they may be selectively angled relative to the such surface at the point of connection in order to potentially optimize their therapeutic effect.

In another form of the invention, the therapeutic device has sides or side edges which may be contoured and have formed thereon a plurality of projections, which may be arranged in rows. The side edge may be somewhat concave, designed to release tightness in the muscles in the front and side of the neck when held adjacent to those muscles by the hand of the user. Instead of having a concave structure, the sides may be downwardly sloped from the outer edges inwardly to the center, where a gentle curve is formed to accommodate the neck or other body part of the user, and moved thereover to generate the beneficial therapeutic massage effect.

The ridge may be located at the front end or the rear end of the operating surface, or even both ends in one embodiment, and project in a generally vertical and upward position from the operating surface of the therapeutic device. The ridge, in combination with the central convex operating surface of the device which has an arc shape, is designed to hold and cradle the suboccipital bones of the user.

### BRIEF DESCRIPTION OF THE DRAWINGS

In the drawings:

FIG. 1 is a top view of the therapeutic device in accordance with one aspect of the invention;

FIG. 2 is a bottom view of the therapeutic device as shown in FIG. 1 of the drawings;

FIG. 3 is a first side view of the therapeutic device as shown in FIG. 1 of the drawings;

FIG. 4 is a second side view, opposite that of the first side, of the therapeutic device as shown in FIG. 1 of the drawings;

FIG. 5 is a top end view of the therapeutic device as shown in FIG. 1 of the drawings;

FIG. 6 is a bottom in view of the therapeutic device as shown in FIG. 1 of the drawings;

FIG. 7 is a top perspective view from the second side showing a therapeutic device as illustrated in FIG. 1 of the drawings;

FIG. 8 is a top perspective view from the first side showing a therapeutic device as illustrated in FIG. 1 of the drawings;

FIG. 9 is a schematic view of a therapeutic device in accordance with a further aspect of the invention, when compressed; and

FIG. 10 is a schematic view of the therapeutic device as shown in FIG. 9, when not in a compressed condition.

### DETAILED DESCRIPTION OF THE INVENTION

Reference is now made to the accompanying drawings which show an embodiment of a therapeutic device in accordance with the invention. Note that the therapeutic device illustrated and described herein is exemplary, and many different therapeutic devices having varied shapes, configurations, surface arrangements and other structural attributes would fall within the scope of the invention.

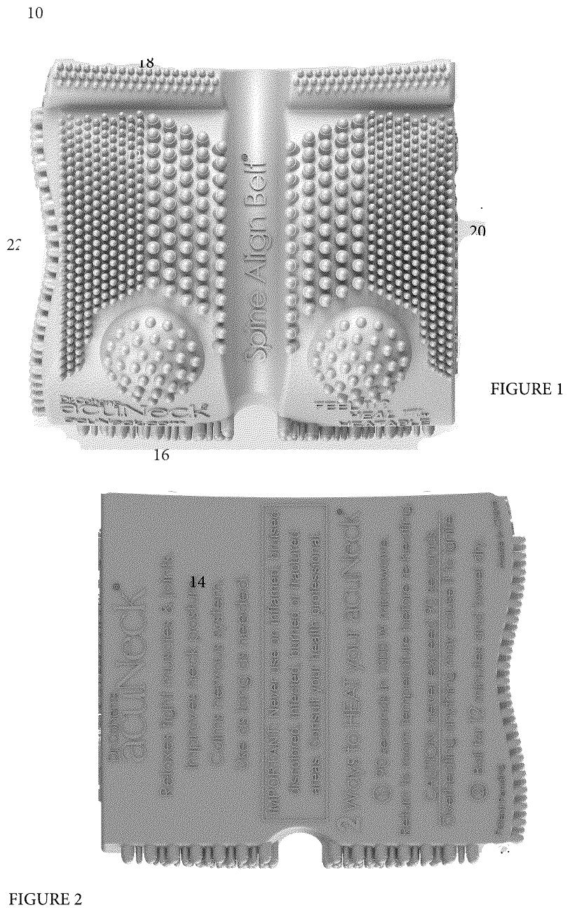

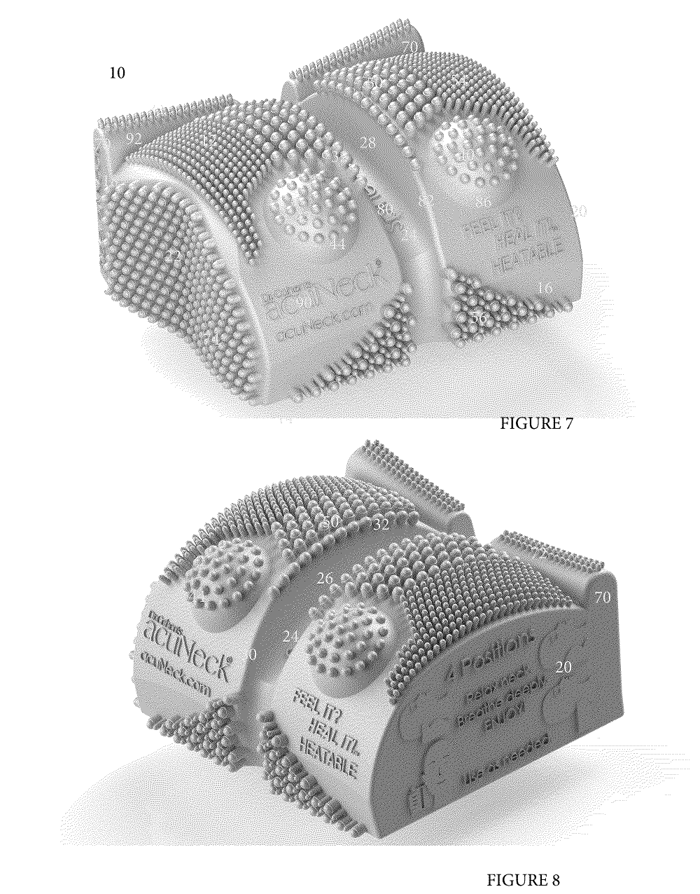

FIGS. 1 to 8 of the drawings illustrate a therapeutic device 10. The therapeutic device 10 has a top surface 12, a bottom surface 14, a front 16, a rear 18, and sides 20 and 22. The top surface 12 has a generally curved, convex, rounded or arcuate surface configuration extending from the front 16 to the rear 18.

A substantially central recessed groove 24 is formed in the generally central and transverse position across the top surface 12. The central recessed groove 24, which in other embodiments may be positioned off center, has side walls 26 and 28, which may slope outwardly from the rounded base 80 in the embodiment illustrated, and a lip or track 30 is formed at the top 82 of each of the side walls 26 and 28. A row of nibs or projections 32 is located on the lip or track 30, in the middle portion thereof, and in the embodiment shown in these figures, there is an absence of such nibs or projections 32 on the lip or track 30 near the front and the rear thereof. Other embodiments may have differently arranged projections 32 on the lip or track 30, including a series of projections 32 followed by a space followed by a further series of projections 32.

A pair of hemispherical or rounded structures 40 and 42 are formed on the top surface 12 of the therapeutic device 10. Each of these hemispherical structures 40 and 42, as their name implies, is substantially dome-shaped, and has an arcuate or curved upper surface 86. Each of the hemispherical or rounded structures 40 and 42 are positioned such that one edge thereof is near or adjacent to the nibs or projections 32 on the lip or track 30, or to the lip or track 30 itself, such as where there are no projections 32 on the lip 30. The remaining portion of the hemispherical or rounded structures 40 and 42 extend in a direction away from the recessed groove 24, towards the respective edge 22 and 20.

Each of the hemispherical structures 40 and 42 includes a plurality of projections 44 which may be in the form of nubs or nibs and which extend upwardly or away from the rounded surface 86 thereof. These projections 44 are generally at right angles to the surface portion 86 on which they are located at the point of location, so that the projections 44 will not generally have parallel axes, and will extend in different directions. In other embodiments of the invention, however, it may well be that these projections 44, or at least some of them, do have parallel axes, and they may in fact be at any selected and suitable angle relative to the curved surface of the hemispheric structures 40 and 42 at the point of location. This configuration can be determined based on specific needs and treatment regimen. All or some of the nubs 44 may also be more stubby and rounded in shape, compared to other projections on the therapeutic device 10, as will be described below.

Note that the hemispherical structures 40 and 42 may be other than hemispherical, such as part of the spherical, elliptical or partly elliptical, to name some examples. They may have dual types of shapes, or may irregular shapes if this suits the objective of the therapeutic device 10.

The top surface 12 has various groups of projections, and these will be substantially mirror images of each other on each side of the recessed groove 24. Therefore, one side will be described herein. Of course, these sides may not be mirror images. A plurality of large round projections 50, preferably arranged in parallel rows, extend from adjacent the projections 32, away from the recessed groove 28. All or some of these projections 50 extend toward the front end 16, up to a point approximately around the hemispheric structure 40 or 42. These large round projections 50 also extend rearwardly towards the rear 18 of the device 10.

In the center portion of the top surface 12, there are arranged a plurality of small projections 54, which are preferably arranged in a series of parallel rows. These small projections 54 continue from where the large round projections 50 end, and also extend forwardly towards and at least partially around the hemispheric structure 40 or 42, and toward the rear 18 of the device 10.

Also on the top surface 12, toward the front 16, there are a plurality of generally mixed sized projections 56. These comprise a plurality of generally integrated smaller and larger projections 56, arranged in a loose array of rows. The therapeutic device 10 further comprises a generally smooth area 90, upon which no projections are located.

At the rear of the top surface 12, there are a pair of ridges 70, extending generally upwardly from the top surface 12. It will be seen that the central recessed groove 24 runs between these ridges 70. The ridges 70 have sidewalls 92 which are generally smooth, but the top of each ridge 70 has a plurality of outwardly extending projections 72 arranged in rows, and two rows in the embodiment illustrated. These small acupressure nibs on the top surface assist in holding and cradling the suboccipital bones of the end-user. In combination with the therapeutic device's 10 rounded arc or curved top surface, there is created a notable traction effect which encourages spinal decompression throughout the cervical spine.

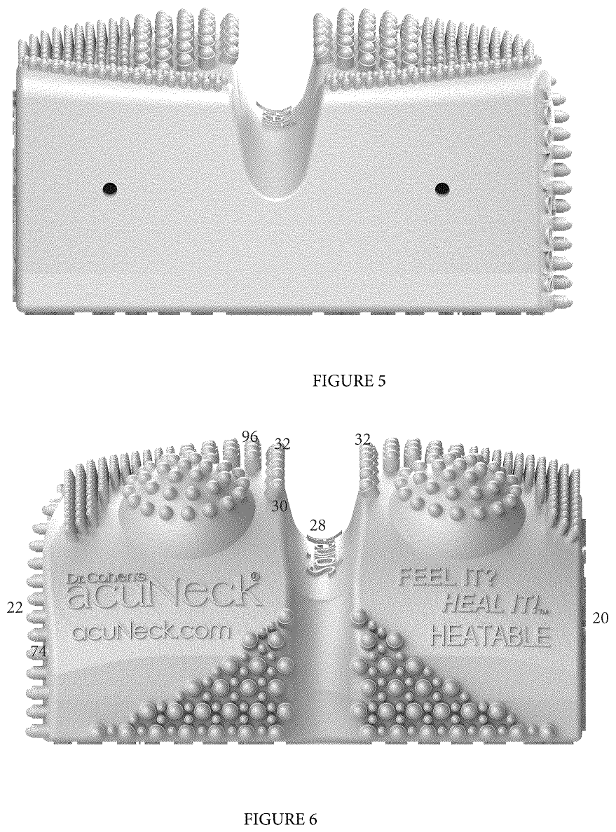

It will be seen that the top surface 12 is somewhat rounded or arced as it extends from the central recessed groove 24 to each of the sides 18 and 20 respectively. This is best seen in FIGS. 5 and 6 of the drawings. The top surface 12 has its acme 96 where the larger projections 50 are nearer the recessed groove 28 and slopes downwardly gradually as it approaches the sides 18 or 20. The projections 32 on the lip 30 are positioned slightly below the acme 96. This configuration may follow the shape and form of the spine and lateral body parts about it, providing better comfort and potentially improved effects from the massaging process.

The side 22 of the therapeutic device 10 is also concave, or as described above may have sloping lateral walls which form a hollow in the middle of the side 22, and has over a major portion of it surface a series of projections 74, which constitute acupressure points. These acupressure points, in combination with the concave orientation of the surface of the edge 22, are designed to release tightness in the muscles in the front and side of the neck. Typically, the device 10 is held against the neck muscles by hand, with this edge 22 abutting against the body of the user, and may be held stationary with pressure, or moved over the neck and body to stimulate the muscles and associated parts.

As described above, all or some of the projections or nibs 50, 54, 32, 72 on the top surface 12 of the therapeutic device 10 are intended to massage or contact muscle, ligaments and other tissues on and around the neck area of the user. The spine of the user will be accommodated in the central recess 24. All of the various projections, in their potentially different configurations, sizes, densities and other characteristics, over the surfaces and components of the therapeutic device 10, provide acupressure points, which have the combined effect of relaxing, soothing or otherwise treating the muscles of the user, and stimulating the user by the presence of the therapeutic device 10 to release tight musculature and encourage structural normalization of the spinal joints and connective tissue. The device may be used for certain times each day, such as for periods of 10 to 15 minutes, and may be placed behind the neck while in the sitting position, with the bottom 18 against a chair or other surface, or under the neck when lying down. This may help in counteracting the negative ramifications of the head tilting and forward leaning position created by the use of a cell phone, computer, or other working conditions.

An important feature of the therapeutic device 10 of the invention is the fact that it can be heated, and preferably retain the heat for an extended period of time. The therapeutic device may be heated in that it is comprised of a material which can, for example, be placed in boiling water or placed in a microwave oven, for a given period of time to heat it, to have a desired or selected temperature or warmth factor. The material preferably has properties which allow it to retain heat for an extended period of time. In another form of the invention, the therapeutic device 10 may comprise one or more hollow chambers contained within it, and the hollow chambers may comprise a fill material, such as water, air, flax, to name a few, which can be heated, once more by placing the device in boiling water or in a microwave oven.

In yet a further version, the therapeutic device 10 of the invention may comprise one or more hollow chambers, heating elements within the hollow chambers, and an electrical connector at the periphery or outer surface of the device which allows the heating elements to be connected to a source of power which will heat the elements, and thus the fill material surrounding the elements. In this embodiment, the heating elements may be powered before use to heat the fill material, or the therapeutic device 10 may in fact be connected to the source of power while in the process of being used for muscle and tissue massage, so that the fill material and the device remains at a warm, and selected, temperature for the duration of the therapeutic treatment. This is useful especially if there is an extended duration for the treatment. In this regard, the therapeutic device 10 of the invention is intended to be used, in one embodiment, for extended periods while the user is working before a computer, speaking on the phone, and in other situations. There may be temperature sensors or timers which heat the fill material for a given period of time, or until a specific temperature is reached, and then switched off until needed to reheat once more. A uniform temperature can therefore be achieved and maintained. The invention may also comprise controls, automatic or manual, for adjusting or modulating the temperature to which the therapeutic device 10 may be heated, since different users or different types of treatments may respond better at different temperature settings, and different or varied heat settings may be desired at over a period of time.

The device of the invention may provide acupressure points, and heat increases the blood flow and physically loosens contracted muscle, connective tissue and joints resulting in decreased pain, improved mobility and enhanced athletic performance. An overall relaxation effect may occur, sometimes within a few minutes of commencing use of the device of the invention, as pain is relieved, muscular and connective tissue and joint tightness releases, and natural pain killers and sedatives may be released from the central nervous system and the heating effect soothes the individual.

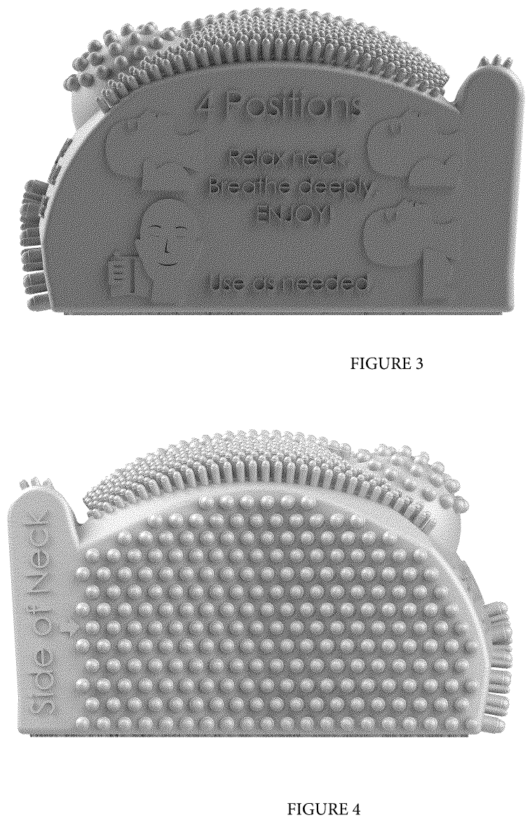

In one form of the invention, the therapeutic device 10 may be used by placing behind the back or the neck, specifically in the hollow of the neck, while seated, although it also may be used when lying down in bed. It is small and easily portable, and can thus be used at home, in the office, while traveling in a vehicle, or during leisure activities. One preferred position for the therapeutic device 10 of the invention is to locate it, as mentioned, around the neck area and possibly in the hollow of the neck between the head and the back or shoulder portion. The spine, whether in the neck or the back, may be received within the recessed groove. The compactness and configuration of the therapeutic device 10 has the effect of causing the user to sit in a more upright position with the head supported or guided to a better position, or lying on a surface in a straighter or more ergonomic position, as seen in the schematics on the device surface as shown in FIG. 3 of the drawings. The therapeutic device 10 of the invention has a flat lower or bottom surface 18 so that it may engage the back of a chair, or a mattress, and stay in the selected position due to traction provided by the material surface, leading to some frictional engagement to reduce slippage or sliding. Positioning of the therapeutic device 10 stimulates the user to sit in a position which achieves more easily the natural curvature of the spine and neck, may stop the head from tilting forward, and cause the user to sit upright a little more effortlessly. This may help to reduce fatigue, any pain resulting from a person's natural tendency to slouch or crouch over, stiffness, or organ compression which is one of the consequences of a bent over posture and the tilting or drooping of the head when using the phone or in other situations.

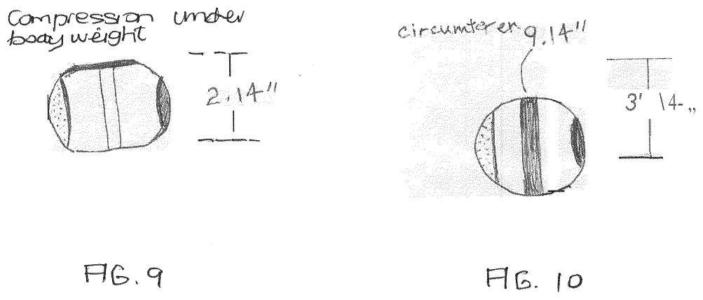

Reference is now made to FIGS. 9 and 10 of the drawings which illustrate a further embodiment of the present invention. In FIG. 9 of the drawings, there is shown a therapeutic massage device which has been compressed under the body weight of a person, while in FIG. 10 of the drawings, the therapeutic massage device is shown in the uncompressed condition. In one form of the invention, the regular uncompressed diameter of the therapeutic massage device gives the device a more rounded or arced configuration in the central portion thereof (see FIG. 10), while the device when compressed has a configuration which is more cylindrical at its central portion (see FIG. 9), although it need not be completely cylindrical, while being domed or rounded at each of the ends. The therapeutic massage device shown in FIGS. 9 and 10 illustrate the presence of a central spinous canal or recess, which is adapted to receive the spinal portion of the person undergoing a massaging operation of the device. The central spinous canal may be of varying thicknesses or widths according to specific needs, as well as varying depths, for the same reason. Further, the spinous canal may not be centrally located, but may be off-center, depending upon the design and purpose of the device.

In accordance with one embodiment only of the invention as shown in FIGS. 9 and 10, a specific device may have the following features and dimensions:

(1) Height (when the device is placed on its side) is about 2.9 inches to 3.50 inches with an optimal height of about 3.1 to 3.35 inches.

(2) Circumference of recessed central groove (to accept vertebral spinous processes of user) of about 8.5 inches to 9.5 inches with an optimum circumference of 8.8 to 9.35 inches.

(3) A durometer of about 35 to 45 with an optimum durometer of about 38-42.

(4) A specific compressive capacity using about a 160 to 190 pound person lying on the device so as to have the effect of reducing its height from, for example, an initial height of about 3 to 3.5 inches down to about 2.0 to 2.6 inches, with a height of 2.1-2.4 inches being an optimum compressive height.

(5) Bi, or other, -level nibs located over all or a selected surface area of the device such as the ends. The overall nib height may be from about 0.2 to 0.75 inches with an optimum nib height of about 0.25 to 0.60 inches. The top nib width may be about 0.05 to 0.5 inches with an optimum width of about 0.1 to 0.3 inches, while the lower nib width may be about 0.2 to 0.75 inches with an optimum width of about 0.3 to 0.6 inches.

An important feature of the device is the fact that it can be placed in a microwave oven to heat or raise the temperature of the inner core thereof, which may be filled with air or any other material suitable for being so heated. In one embodiment of the invention, the device may be placed in a microwave oven for about 50 seconds in 1000 watt microwave, which may produce about 72 minutes of 102 degrees heated devices for improved massage properties as a consequence of the heating and the ability to maintain warmth for a usable and/or effective amount of time.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A therapeutic device comprising:
an upper massage surface having a generally central spinous channel, a first domed portion on a first lateral side of the central spinous channel and a second domed portion on a second lateral side of the central spinous channel;
a lower base surface;
a front edge;
a rear edge, the upper massage surface extending between front edge and the rear edge;
a first lateral edge on one side of the therapeutic device and a second lateral edge on an opposing side of the therapeutic device;
a first ridge near the rear edge extending upwardly between the central spinous channel and the first lateral edge; and
a second ridge near the rear edge extending upwardly between the central spinous channel and the second lateral edge.

2. A therapeutic device as claimed in claim 1 wherein the first domed portion comprises an outer curved surface and a plurality of projections extending upwardly and outwardly from the outer curved surface.

3. A therapeutic device as claimed in claim 2 wherein the first domed portion has a circumferential edge at its base, the circumferential edge being adjacent the central spinous channel.

4. A therapeutic device as claimed in claim 3 wherein the first domed portion has a diameter which is about one fourth of the distance between front edge and the rear edge.

5. A therapeutic device as claimed in claim 3 wherein the first domed portion has a diameter which is about one third of the distance between front edge and the rear edge.

6. A therapeutic device as claimed in claim 3 wherein the first domed portion is located on the upper massage surface in a position nearer the front edge.

7. A therapeutic device as claimed in claim 3 wherein the first domed portion is adjacent the central spinous channel about equidistant from each of the rear edge and front edge.

8. A therapeutic device as claimed in claim 3 wherein the plurality of projections extending outwardly from the outer curved surface of the first domed portion each have a base, a short cylindrical shaft portion and a rounded end, the projections having an axis which is about normal to the outer curved surface where the base attaches to the outer curved surface.

9. A therapeutic device as claimed in claim 8 wherein the rounded ends of the projections together define an arcuate configuration with spaces therebetween.

10. A therapeutic device as claimed in claim 1 wherein the upper massage surface has an apex between the front and rear edges adjacent the central spinous channel, curves down on each side toward the front and rear edges respectively, and further curves downwardly form the central spinous channel toward the first and second lateral edges respectively.

11. A therapeutic device as claimed in claim 1 further comprising a plurality of large projections on the upper massage surface on each side of the central spinous channel, the plurality of large projections being positioned on the upper massage surface so as to extend from along the central spinous channel toward the first or second lateral edge respectively.

12. A therapeutic device as claimed in claim 11 further comprising a plurality of small projections extending from the large projections to the first or second lateral edge receptively.

13. A therapeutic device as claimed in claim 12 wherein the large projections and the small projection each have a base, a cylindrical shaft and a hemispherical end portion.

14. A therapeutic device as claimed in claim 13 further comprises a plurality of mixed size projections near the front edge thereof.

15. A therapeutic device as claimed in claim 1 wherein the first ridge and the second ridge each have a plurality of ridge projections extending outwardly therefrom.

16. A therapeutic device as claimed in claim 1 wherein at least one of the first or second lateral edges has a pair of opposing lateral wall portions which taper or slope inwardly toward the center of the lateral edge, a concave curved portion at about the center of the lateral edge, and a plurality of lateral wall projections extending outwardly from the lateral edge.

17. A therapeutic device as claimed in claim 1 comprised of a material which can be heated and which is able to maintain heat.

18. A therapeutic device as claimed in claim 1 wherein the device has an interior and the device further comprises a fill material in the interior of the device which is heatable and which is able to maintain heat.

19. A compressible therapeutic device comprising:
a body comprised at least in part of a compressible or resilient material, the body having a central portion and opposite side portions, wherein the central portion is convexly curved or rounded when not compressed and substantially flat at least along a part thereof when in a compressed condition;
a circumferential spinous recess canal formed in the central portion of the body; and
a core within the body which is capable of retaining heat when warmed by an outside source to impart heat to the device.

20. A device as claimed in claim 19 wherein the body has a maximum outer diameter at its central portion when not compressed, and a compressed outer diameter which is less than the maximum outer diameter at its central portion when compressed.

21. A device as claimed in claim 19 further comprising a plurality of ribs or nibs formed on selected surface area of the body.
